(19) United States
(12) Patent Application Publication
(10) Pub. No.: US 2012/0070104 A1
(43) Pub. Date: Mar. 22, 2012

(54) DYNAMICALLY ADJUSTABLE STORAGE METHOD AND APPARATUS

(76) Inventor: Celia Antonio, Ottawa (CA)

(21) Appl. No.: 13/234,206

(22) Filed: Sep. 16, 2011

Related U.S. Application Data
(60) Provisional application No. 61/383,383, filed on Sep. 16, 2010.

(30) Foreign Application Priority Data
Mar. 31, 2011 (CA) 2736169

(51) Int. Cl. B65D 33/00; B31B 41/00

(52) U.S. Cl. 383/105; 493/210

(57) ABSTRACT

The design of items for storage is today defined by containers that are primarily of fixed external dimensions and do not adjust to the quantity of their contents. It would be beneficial to provide a means of allowing an item of storage, such as a backpack, lunch tote, briefcase, that adjusts automatically in dependence upon the contents that the user placed within. It would be further beneficial if the means could be deployed on a variety of other storage items giving a “one size fits” such that with only a few items stored within it the storage item does not occupy unnecessary space.

### FIELD OF THE INVENTION

This invention relates to means of storing items and more specifically to storage containers that dynamically adjust to the contents stored within.

### BACKGROUND OF THE INVENTION

Today millions of people will go about their everyday lives taking a variety of lunch totes and lunchboxes. Others will seek to store items, pack for vacations, go camping, take laptop computers to lectures, and take papers to/from work, school, etc with a variety of backpacks, totes, and hand luggage. Each of these will be of a traditional design with an outer body of predetermined dimensions and in the majority of them at least one internal wall separating the body into multiple compartments with them. These lunch totes, lunchboxes, backpacks etc typically having closing mechanisms based upon zips or loop-and-hook.

With these totes if the user places only a couple of items into them then the items will generally move around as the tote is large enough to hold quite a large number of items. Otherwise the user will have to possess multiple totes so that if carrying only a couple of items they use one, with more items another tote, and with more items yet another tote. Clearly the latter is not an economic or feasible solution for users, and additionally does not provide flexibility to both start with more items and return with less or vice-versa. Whilst the former provides flexibility it does not present an optimum solution when only a few items are stored within them.

Typical examples of current lunch totes are depicted in FIG. 1 by first to fifth lunch totes 110 through 150. First lunch tote 110 being simply a disposable brown paper bag whilst second and third lunch totes 120 and 130 respectively represent typical lunch totes (or lunch totes) for a child and adult respectively. Fourth lunch tote 140 shows the typical contents packed into a lunch tote which according to the volume of the tote and items to be packed result in their movement, etc. Fifth lunch tote 150 depicts a typical solution to this problem wherein the lunch tote 152 is used to carry a plastic tub 154 within which the user has packed their food. Accordingly, even if only one small item is placed within such a lunch tote the basic dimensions and volume that the lunch tote occupy remain essentially unchanged except with the brown paper tote of lunch tote 110 that can be folded, rolled, or scrunched down.

Likewise in FIG. 2 typical examples of current luggage and backpacks are shown. Backpack 210 being typical of bags carried by school children, workers etc and comprises a body 210D with straps 210C within which are two compartments 210A and 210B closable by zips. Rucksack 220 extends this approach in that the back and sides of the rucksack are covered with multiple pockets for small items whilst there is a large single inner volume for the storage of the main items the user will carry. Wheeled case 230 is typical of luggage employed by users when travelling and comprises a main essentially rigid or semi-rigid body 230A with a handle 230B and wheels 230C. The lid 230D being attached to the body 230A and closing to form the container through a zip. A second zip 230E is provided which unzips releasing a small amount of flexible material that is disposed in a ring such that it provides a small amount of extension to the body 230A if the user overloads the primary volume of the body 230A. Luggage 240 comprising carry-on 240A, suitcase 240B and wheeled suitcase 240C do not even provide this and are constructed from rigid materials. In all instances of current luggage and backpacks there is no substantial reduction in the volume of the item is only filled with a few items. None of these items adjust to the volume of the items being stored within.

In some circumstances this can cause problems for the user, such as a child carrying their school backpack with only a couple of heavy books that then tilt backwards either unbalancing them or over time causing back problems. Likewise with lunch totes when filled with only a couple of items these easily move around, which in the instance they are fruit leads to bruising and spoiling or with other dishes them being turned upside down as their containers flip over.

Within the prior art there are examples of adjustable containers. For example, F. Pedrini in U.S. Pat. No. 5,314,046 entitled “Expandable Container with Internal Manual Operation System” which consists of two hollow bodies, one of which fits inside the other, the inner one being provided with a closed bottom. Accordingly, the user can use the container with the inner body either raised inside the outer or dropped down. However, the design is geared towards suitcases or briefcase type containers rather than backpacks, lunch tote etc. By contrast E. W. Meyer et al in U.S. Pat. No. 6,394,652 entitled “Flexible Bags having Stretch-to-Fit Conformity to Closely Accommodate Contents in Use.” These are designed to precisely accommodate the dimensions and volumes of the contents placed within in for applications where excess interior space may lead to degradation of the contents due to trapped air, and in other applications such as colostomy bags it is desirable to minimize the size of the bag to the volume of the contents. These bags therefore being targeted to such applications, garbage bags etc.

Likewise D. Schulman in U.S. Pat. No. 6,190,045 entitled “Flexible Storage Container” which is essentially a tubular bag or container constructed with two end mounted holes and two side mounted elasticated holes for easy access to items in the middle of the container without removing the other contents. This design clearly is not addressing the requirements of portable carriers such as backpacks, lunch totes etc. Accordingly it would be desirable to provide a means of allowing an item of storage, such as a backpack, lunch tote, briefcase, that adjusted automatically in dependence upon the contents that the user placed within allowing them to be retained without substantial freedom to move. It would be further beneficial if the means could be deployed on a variety of other storage items giving a “one size fits” such that with only a few items stored within it the storage item does not occupy unnecessary space allowing multiple items to be located within the same area each containing different categories of item, i.e. clothing, shoes, magazines, photograph albums, allowing storage solutions to have increased ease of use and flexibility. At present most storage in these circumstances is based upon fixed dimension, plastic totes such as tote 250 and small totes 260 in FIG. 2.

Accordingly it is an object of the present invention to provide a means of providing storage containers for multiple applications that dynamically adjust to the contents placed into them by the user as a result of the actual process of the user placing the items into the container and closing it.

### SUMMARY OF THE INVENTION

It is an object of the present invention to obviate or mitigate at least one disadvantage of the prior art.

In accordance with an embodiment of the invention there is provided a method comprising providing a layer of a first material that is flexible and attaching an elastic element to the layer of first material in a predetermined position to form a concertina layer, the attachment being performed with the layer of first material substantially extended and the elastic element extended by a predetermined amount, wherein the concertina layer forms a predetermined portion of a storage container that adjusts dimensions in at least one axis according to the contents placed within.

In accordance with another embodiment of the invention there is provided a method comprising providing first and second walls of a storage container, providing a third wall of the storage container connected to each of the first and second walls and comprising at least a layer of a first material that is flexible and an elastic element attached to the layer of material at a predetermined location, wherein the sidewall is continuously adjustable between a first state and a second state, the first state being with the elastic member at a first length such that the layer of material is in a concertina structure and the second state being with the elastic member extended until the layer of material is at maximum extension.

In accordance with another embodiment of the invention there is provided a device comprising a first wall, a second wall, a third wall of the storage container connected to each of the first and second walls and comprising at least a layer of a first material that is flexible and an elastic element attached to the layer of material at a predetermined location, wherein the sidewall is continuously adjustable between a first state and a second state, the first state being with the elastic member at a first length such that the layer of material is in a concertina structure and the second state being with the elastic member extended until the layer of material is at maximum extension.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts typical lunch totes according to the prior art;

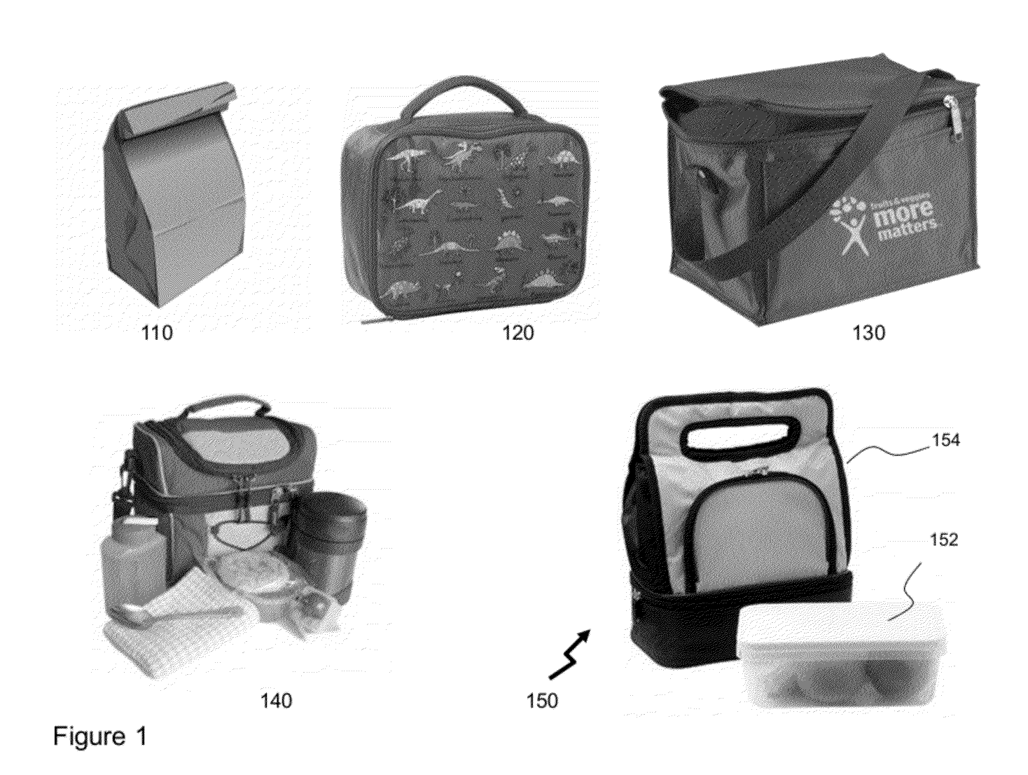

FIG. 2 depicts typical luggage and backpacks according to the prior art;

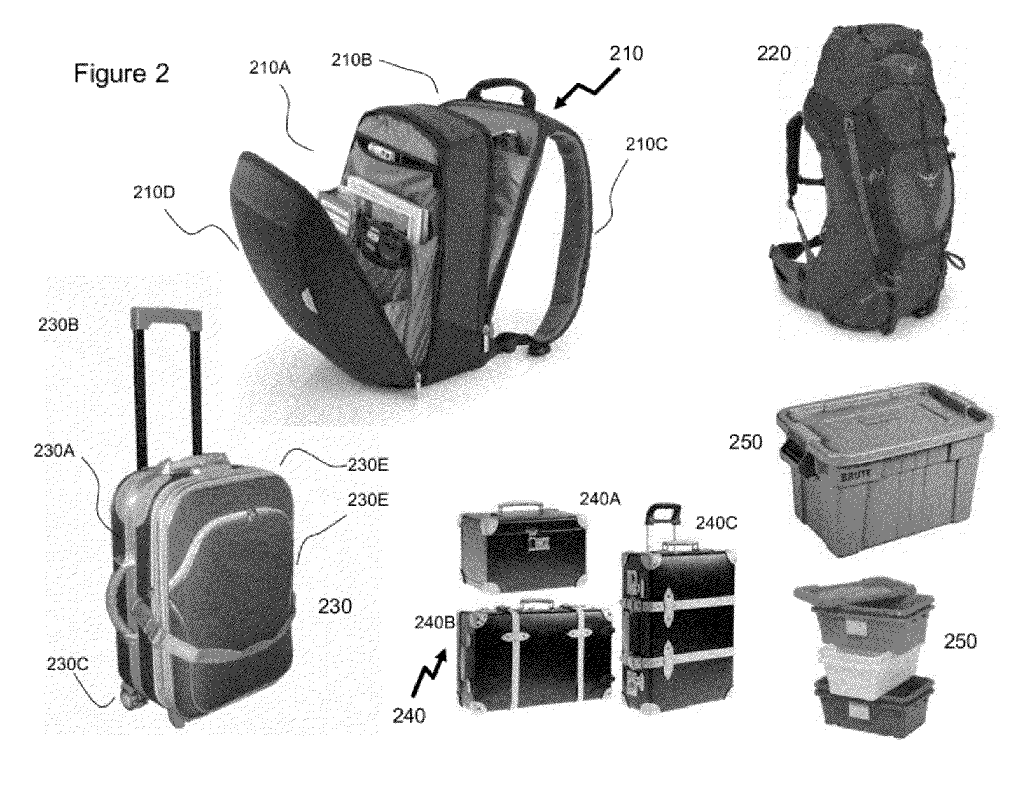

FIG. 3 depicts a storage container according to a first embodiment of the invention;

FIG. 4 depicts a storage container according to the first embodiment of the invention at different stages of dynamic adjustment to the contents provided within;

FIG. 5 depicts a storage container according to the first embodiment of the invention at a stage of dynamic adjustment to a single item of contents being provided within;

FIG. 6 depicts a storage container according to the first embodiment of the invention at a stage of dynamic adjustment to multiple items of contents being provided within;

FIG. 7 depicts a storage container according to a second embodiment of the invention;

FIG. 8 depicts a storage container according to the second embodiment of the invention at different stages of dynamic adjustment to the contents provided within;

FIG. 9 depicts a storage container according to the second embodiment of the invention at a stage of dynamic adjustment to a couple of items of contents being provided within;

FIG. 10 depicts a storage container according to the second embodiment of the invention at a stage of dynamic adjustment to multiple items of contents being provided within;

FIG. 11 depicts a method of providing the dynamic adjustment according to a third embodiment of the invention;

FIG. 12 depicts a method of providing the dynamic adjustment according to a fourth embodiment of the invention; and

FIG. 13 depicts a storage container according to a fifth embodiment of the invention.

### DETAILED DESCRIPTION

The present invention is directed to means of storing items and more specifically to storage containers that dynamically adjust to the contents stored within. The means providing storage containers for multiple applications that dynamically adjust to the contents placed into them by the user as a result of the actual process of the user placing the items into the container and closing it.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

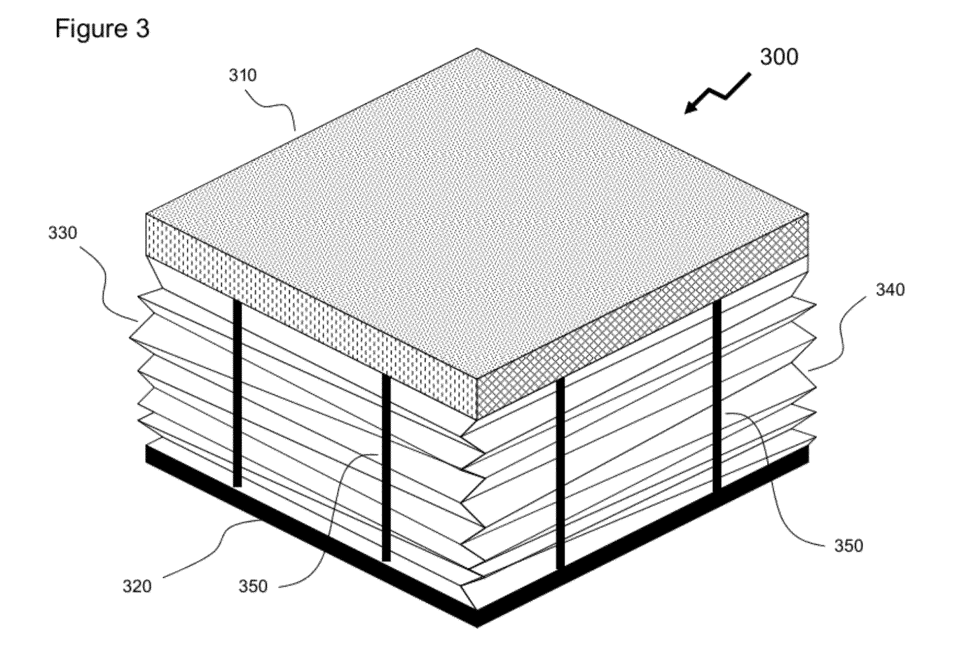

Referring to FIG. 3 there is depicted a storage container 300 according to a first embodiment of the invention. As shown storage container 300 comprises a lid 310, a base 320 and first and second sidewalls 330 and 340, being two of the four sidewalls wherein the others are not shown or identified for clarity. The base 320 being formed of a material providing reasonable rigidity such that when the storage container 300 is picked up the bottom does not distort substantially. The storage container 300 for example being picked up as a discrete item either as shown or through the use of a handle attached to the lid 310 for example. The lid 310 is formed from a material meeting requirements of the storage container 300 in terms of function and may be substantially rigid, flexible or intermediate. The first and second sidewalls 330 and 340 being made from a flexible material as they will adjust from an initial state wherein the storage container 300 is empty or filled with a very small container or contents to a final state wherein they are extended to cover the items being stored within up to the maximum that is determined by the dimensions of the materials used to form the first and second sidewalls 330 and 340.

Disposed within each of the first and second sidewalls 330 and 340 respectively are elastic members 350 which allow the first and second sidewalls 330 and 340 to be pulled up around a contents and the attachment of the lid 310 but by virtue of their elasticity once the closing mechanism of the storage container 300 is used reduce the height of the first and second sidewalls 330 and 340 thereby pulling the base 320 and lid 310 together until physically stopped by the contents within. It would be evident that the elasticity of the elastic members 350 could be adjusted according to the target user, being for example of lower elasticity for children and higher elasticity for adults or for containers with wider potential range of dimensions. Accordingly the user may insert items into storage container 300 when the lid 310 is open, pull the sidewalls up and attach the lid 310 to them with ease and have a finished storage container 300 that is only as large as the contents provided within.

It would be evident that the lid 310, base 320, and the sidewalls, exemplified by first and second sidewalls 330 and 340, may be made of plastics allowing easy cleaning with water and cleaning agents. Optionally the plastics may be chosen to allow them to withstand the increased temperatures of being washed within a dishwasher. Whilst within the descriptions of the embodiments of the invention the colour, ornamentation, design etc of the storage containers will not be generally discussed it would evident to one of skill in the art that the designs can be varied with ease, that the colours and ornamentation adapted to the target users, e.g. bright colours and cartoon characters for children, and in some instances may be designed so that they reveal new designs as they are expanded etc.

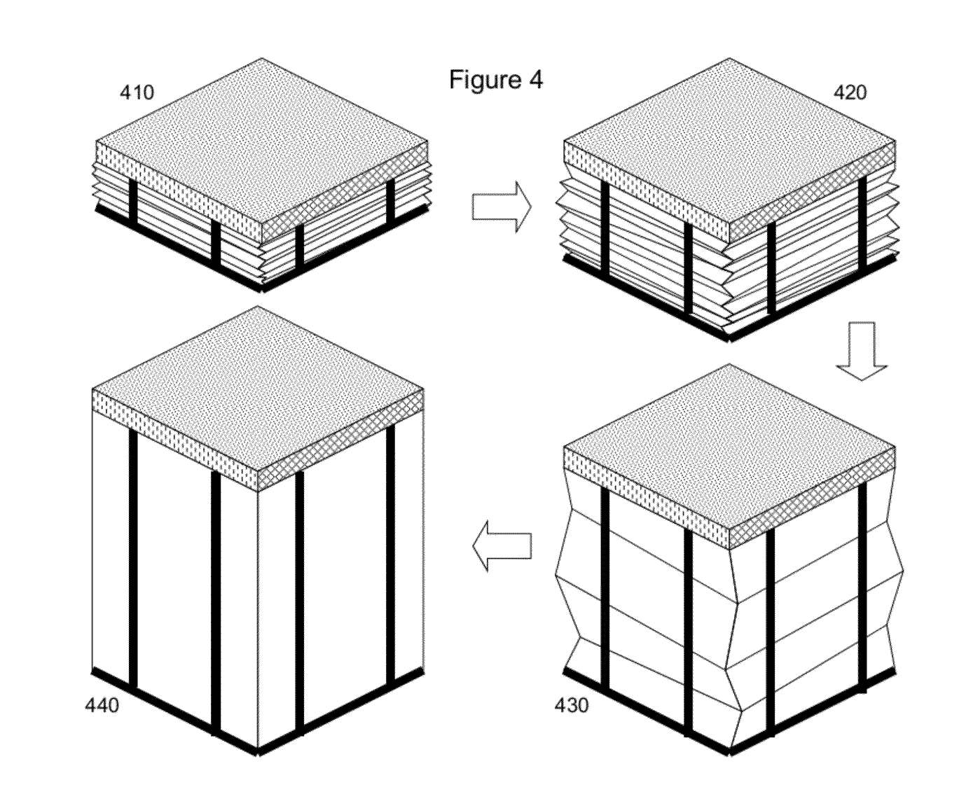

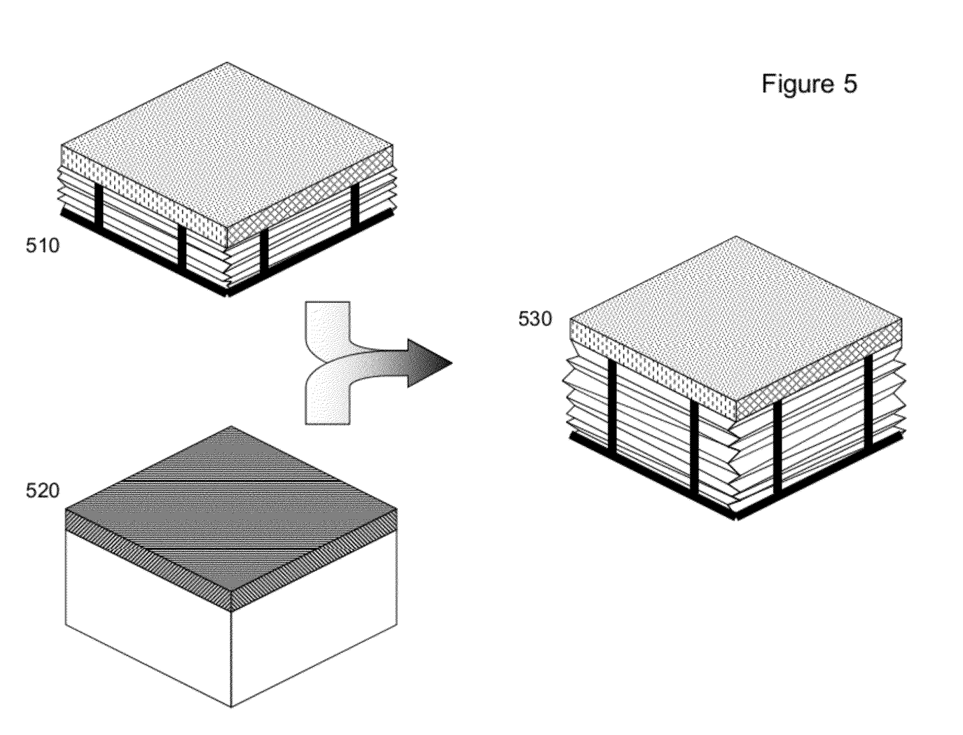

Now referring to FIG. 4 there is depicted a sequence 400 for a storage container to the first embodiment of the invention at different stages of dynamic adjustment to the contents provided within. Accordingly as shown the storage container, such as storage container 300 of FIG. 3 is shown at an initial unexpanded state 410, a first extended state 420, a second extended state 430, and a fully extended state 440. Referring to FIG. 5 the use of the storage container according to the first embodiment of the invention at the first extended state 420 is shown. Accordingly, a user takes the storage container 510, i.e. the unexpanded state 410 in FIG. 4 of a storage container such as storage container 300 of FIG. 3, and inserts within it single item 520 as the contents to be provided within. Upon closing the storage container around the single item 520 the storage container ends up as assembled item 530, being for example at the first expanded state 420 of FIG. 4.

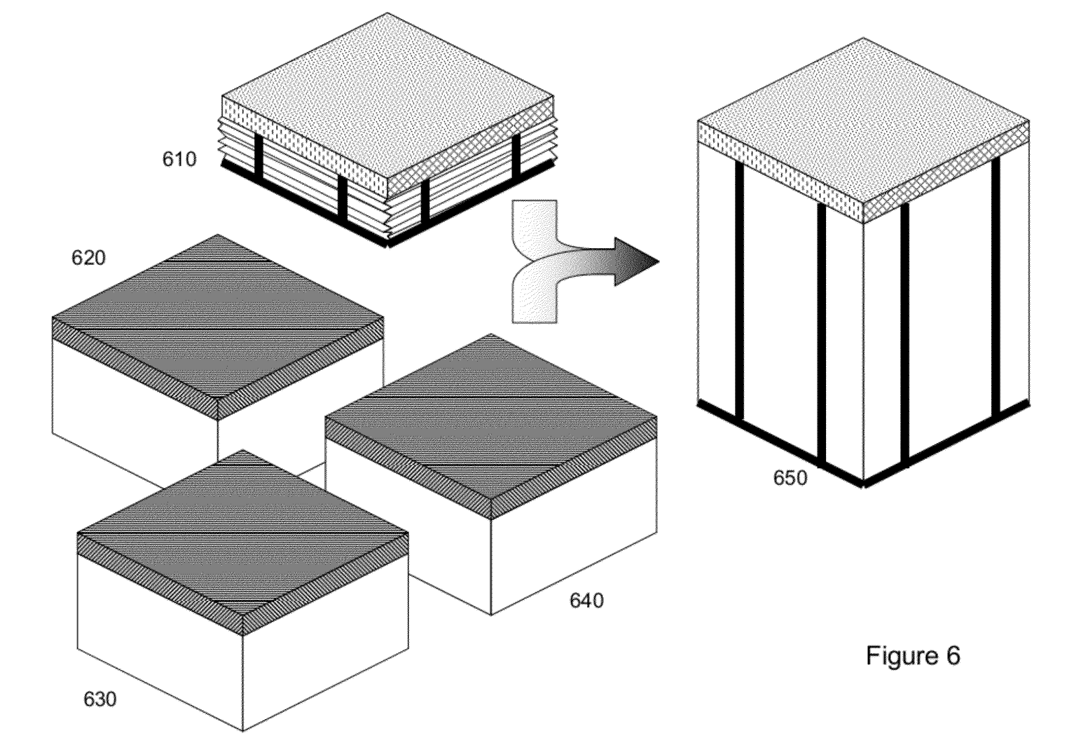

Now referring to FIG. 6 the use of the storage container according to the first embodiment of the invention at the fully extended state 440 is shown. Accordingly, a user takes the storage container 610, i.e. the unexpanded state 410 in FIG. 4 of a storage container such as storage container 310 of FIG. 3, and inserts within it items 620, 630 and 640 as the contents to be provided within. Upon closing the storage container around the items 620, 630 and 640 the storage container ends up as assembled item 650, being for example at the fully expanded state 440 of FIG. 4. Accordingly as will be evident to one of skill in the art the provisioning of contents of different dimensions and different combinations can be accommodated at any point between the initial unexpanded state 410 and the final fully expanded state 440 and the container dimensions to the contents without wasted space.

Referring to FIG. 3 there is depicted a storage container 700 according to a second embodiment of the invention. As shown storage container 700 comprises a back 720, a front 740, first sidewall 730 and top 750. The second sidewall and base are not shown or identified for clarity. The front 740 being formed of a material providing reasonable rigidity such that when the storage container 300 is picked up the front 740 does not distort substantially with the contents. The storage container 700 for example being picked up via one or both handles 710 attached to the back 720 for example. The back 720 is formed from a material meeting requirements of the storage container 700 in terms of function and may be substantially rigid, flexible or intermediate, shaped or unshaped. The first sidewall 730 and top 750 being made from a flexible material as they will adjust from an initial state wherein the storage container 700 is empty or filled with a very small container or contents to a final state wherein they are extended to cover the items being stored within up to the maximum that is determined by the dimensions of the materials used to form the first sidewall 730 and top 750.

Disposed within each of the first sidewall 730 and top 750 respectively are elastic members 760 which allow the first sidewall 730 and top 750 to be pulled around the contents and the attachment of the back 720 but by virtue of their elasticity once the closing mechanism of the storage container 700 is used reduce the depth of the first sidewall 730 and top 750 thereby pulling the front 740 and back 720 together until physically stopped by the contents within. It would be evident that the elasticity of the elastic members 760 could be adjusted according to the target user, being for example of lower elasticity for children and higher elasticity for adults or for containers with wider potential range of dimensions. Accordingly the user may insert items into storage container 700 when the back 720 is open, pull the sidewalls up and attach the back 720 to them with ease and have a finished storage container 700 that is only as large as the contents provided within.

It would be evident that the back 720, front 740, and the four walls, exemplified by first sidewall 730, top 750 and the unidentified second sidewall and bottom, may be made of plastics allowing easy cleaning with water and cleaning agents. Optionally the plastics may be chosen to allow them to withstand the increased temperatures of being washed within a dishwasher. Whilst within the descriptions of the embodiments of the invention the colour, ornamentation, design etc of the storage containers will not be generally discussed it would evident to one of skill in the art that the designs can be varied with ease, that the colours and ornamentation adapted to the target users, e.g. bright colours and cartoon characters for children, and in some instances may be designed so that they reveal new designs as they are expanded etc.

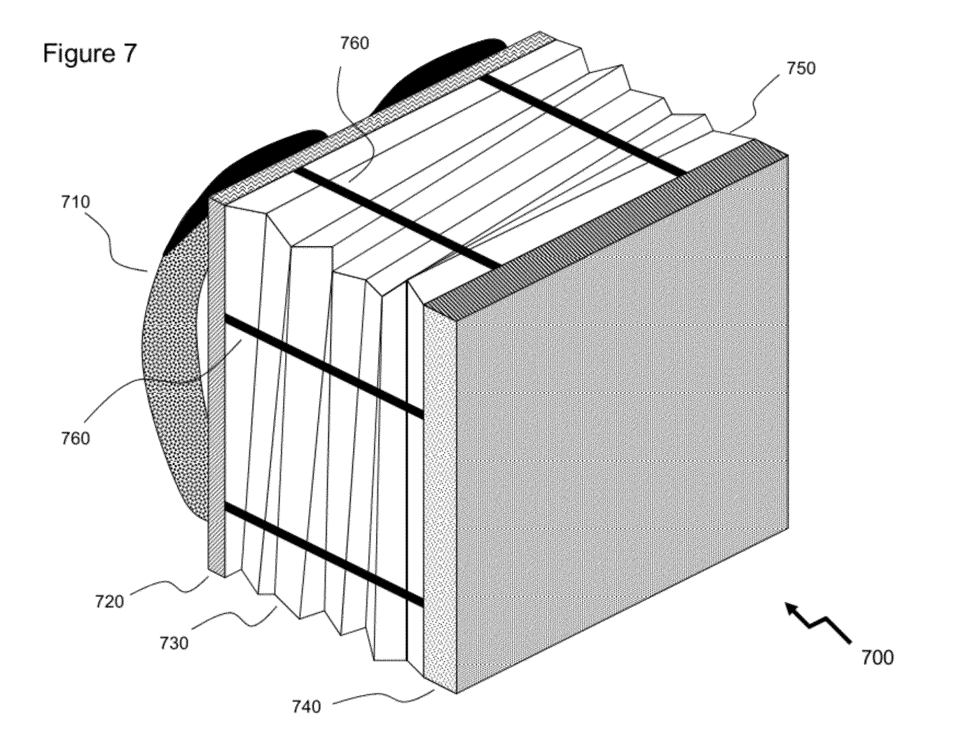

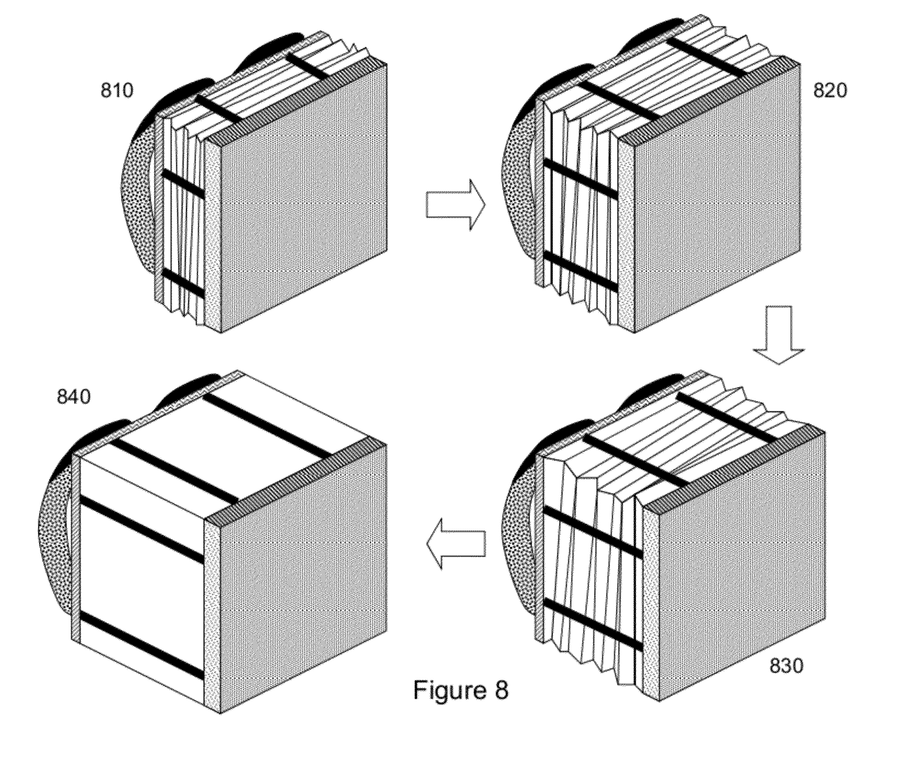

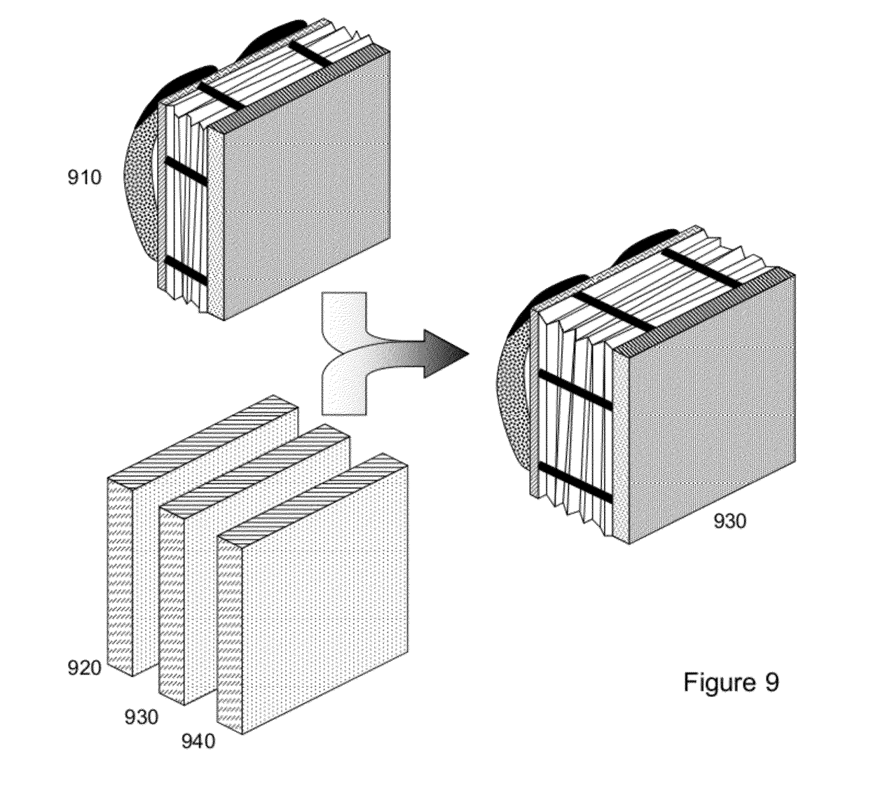

Now referring to FIG. 8 there is depicted a sequence 800 for a storage container to the first embodiment of the invention at different stages of dynamic adjustment to the contents provided within. Accordingly as shown the storage container, such as storage container 700 of FIG. 7 is shown at an initial unexpanded state 810, a first extended state 820, a second extended state 830, and a fully extended state 840. Referring to FIG. 9 the use of the storage container according to the first embodiment of the invention at the first extended state 820 is shown. Accordingly, a user takes the storage container 910, i.e. the unexpanded state 810 in FIG. 8 of a storage container such as storage container 700 of FIG. 7, and inserts within it three thin items 920, 930, and 940 as the contents to be provided within. Upon closing the storage container around these thin items 920, 930 and 940 the storage container ends up as assembled item 930, being for example at the first expanded state 820 of FIG. 8.

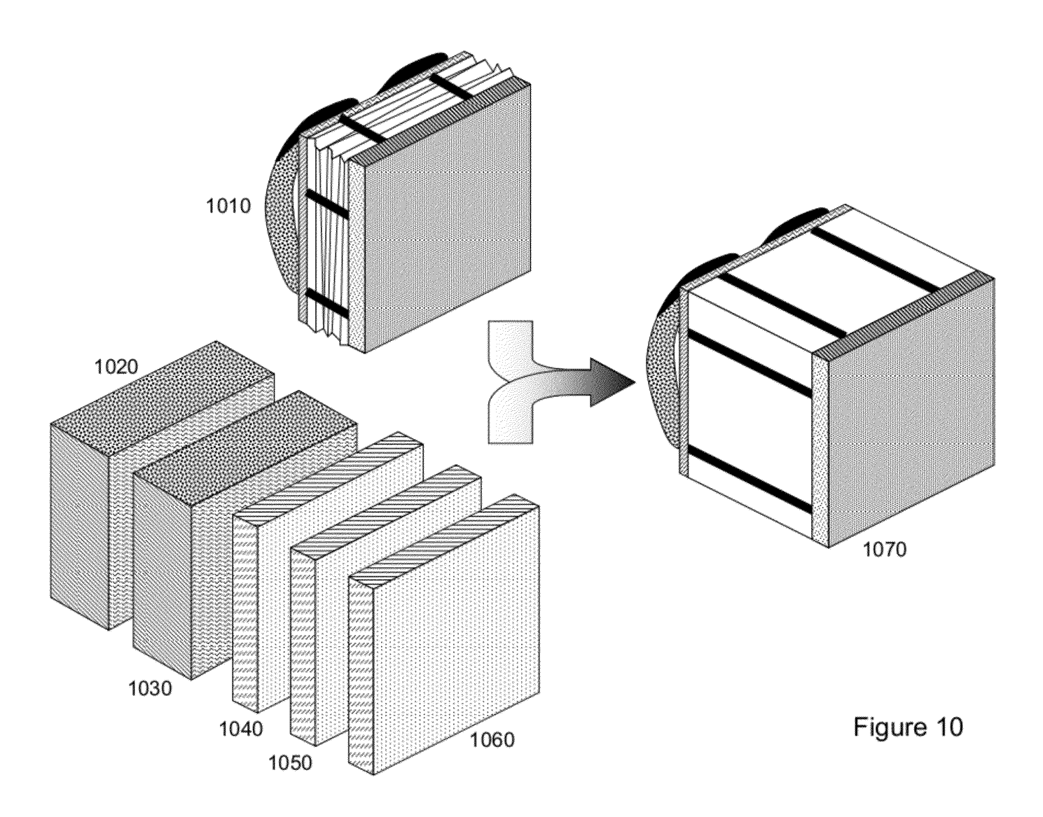

Now referring to FIG. 10 the use of the storage container according to the first embodiment of the invention at the fully extended state 840 is shown. Accordingly, a user takes the storage container 1010, i.e. the unexpanded state 810 in FIG. 8 of a storage container such as storage container 700 of FIG. 7, and inserts within it three thin items 1040, 1050, 1060 and two thicker items 1020 and 1030 as the contents to be provided within. Upon closing the storage container around the three thin items 1040, 1050, 1060 and two thicker items 1020 and 1030 the storage container ends up as assembled item 1070, being for example at the fully expanded state 840 of FIG. 8. Accordingly as will be evident to one of skill in the art the provisioning of contents of different dimensions and different combinations can be accommodated at any point between the initial unexpanded state 810 and the final fully expanded state 840 and the container dimensions to the contents without wasted space.

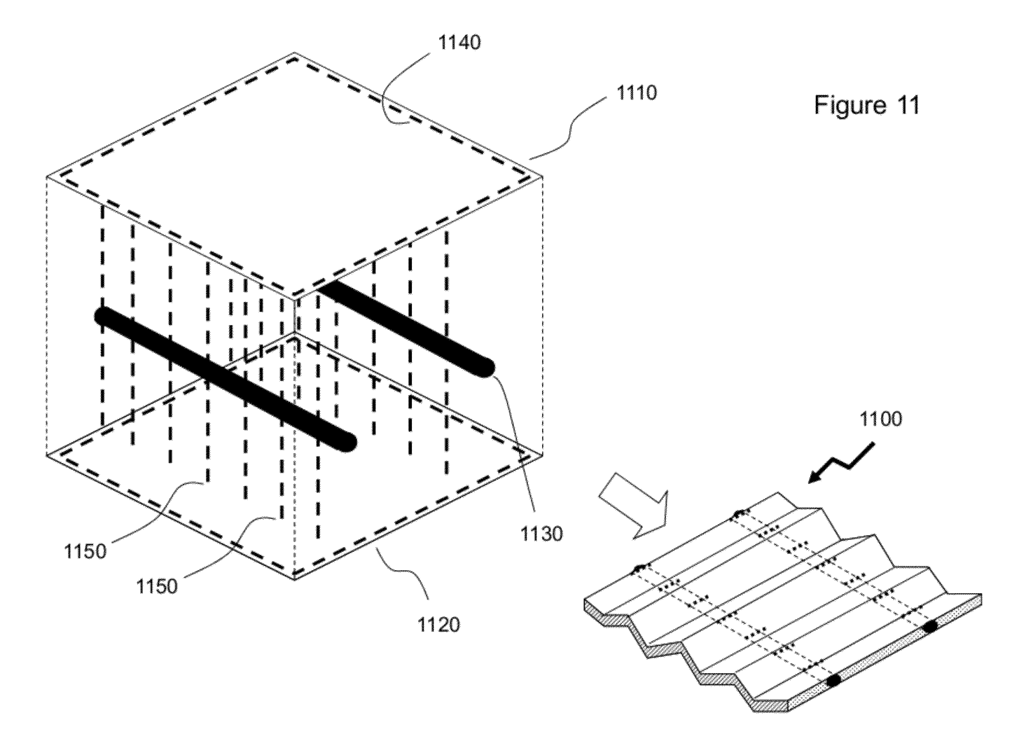

Referring to FIG. 11 there is depicted a method of providing the dynamic adjustment according to a third embodiment of the invention. There being shown a panel 1100 which for example may comprise a sidewall of a container according to the first embodiment, such as first sidewall 310 of container 300 in FIG. 3, or an element of a container according to the second embodiment, such as top 750 of container 700 in FIG. 7. This being constructed from a first sheet 1110 and a second sheet 1120 which have disposed between them are two elastic members 1130. When sandwiched together a first stitching pattern is executed that corresponds to a series of short stitch sequences 1150 that run across the width of the elastic member and attach it to the first and second sheets 1110 and 1120 at multiple points. A second stitch sequence 1140 is then executed that stitches all around the periphery of the first and second sheets 1110 and 1120 respectively. The result being panel 1100 that has two sides and has the elastic members 1130 internal and attached at multiple points.

It would be evident to one skilled in the art that first sheet 1110 may form the inner lining of a container and may be metalized for example in the case of lunch totes or be formed from a material with the same or different properties to that of the second sheet 1120 that would form the outer surface of a container comprising panel 1100. Optionally in the case of providing insulated storage containers additional materials may be placed between the first sheet 1110 and second sheet 1120. Additionally other stitching may be added such as a “quilting” type pattern etch to further link the first sheet 1110 and second sheet 1120 to each other. It would be evident to one skilled in the art that panel 1100 may formed as a long strip with 8 elastic members 1130 disposed within to form a continuous wall for a container or that multiple panels may be joined together. Whilst the embodiments show a pair of elastic members disposed within a wall of the container it would be evident to one of skill in the art that the number of elastic members may be adjusted to the design of the container. For example a long thin container may use a pair on the short sidewalls and 4, 6, 8 etc on the long sidewalls. Further large sheets of materials may employed with long elastic members such that the stitching pattern is repeated multiple times across the large sheet and then the individual sheets are cut out of the large sheet. Such variations being determined by the manufacturer of the container based upon the materials for each sheet, the economics of their production system, etc.

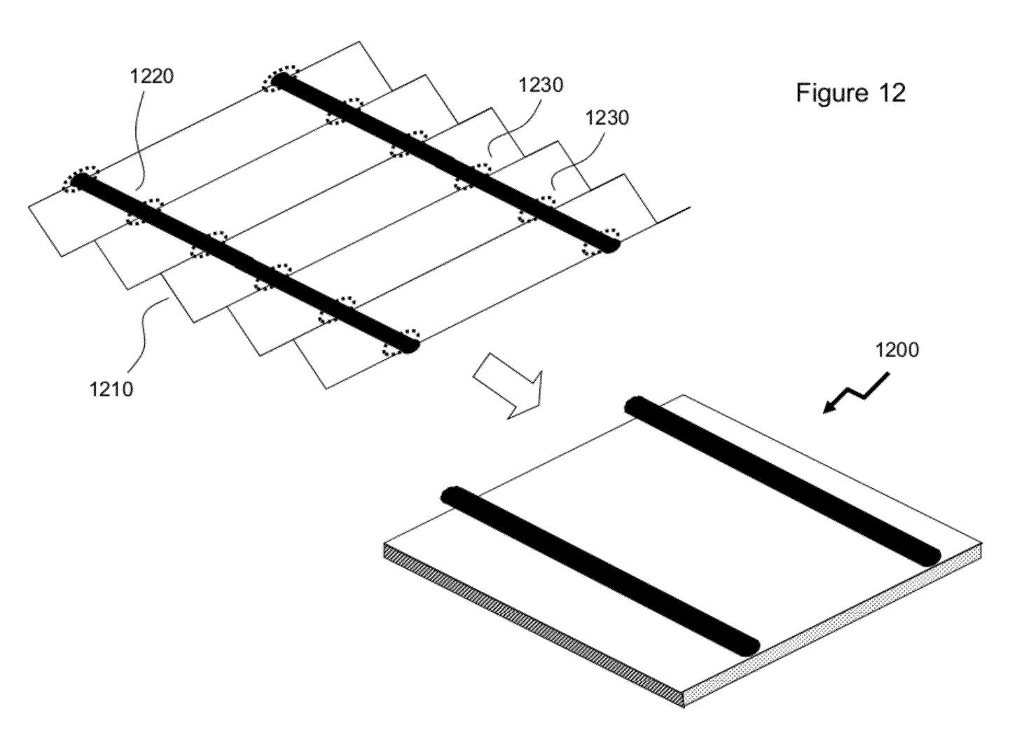

Now referring to FIG. 12 there is depicted a method of providing the dynamic adjustment according to a fourth embodiment of the invention. There being shown a panel 1200 which for example may comprise a sidewall of a container according to the first embodiment, such as first sidewall 310 of container 300 in FIG. 3, or an element of a container according to the second embodiment, such as top 750 of container 700 in FIG. 7. This being constructed from a sheet 1210 which has disposed upon it elastic members 1220. There are then executed a series of short stitch sequences 1230 that run across the width of the elastic member and attach it to the sheets 1210 at multiple points. It would be evident to one of skill in the art that other designs of sheets and elastic members may be provided that result in the required function. Optionally the elastic member 1220 in FIG. 12 or elastic member 1130 in FIG. 11 attached only at the edges of the respective sheets and may be attached in either a relaxed or extended state. Further the shape of the elastic members whilst depicted as essentially circular or elliptical within the embodiments presented supra may be rectangular, flat, triangular or any other cross section appropriate.

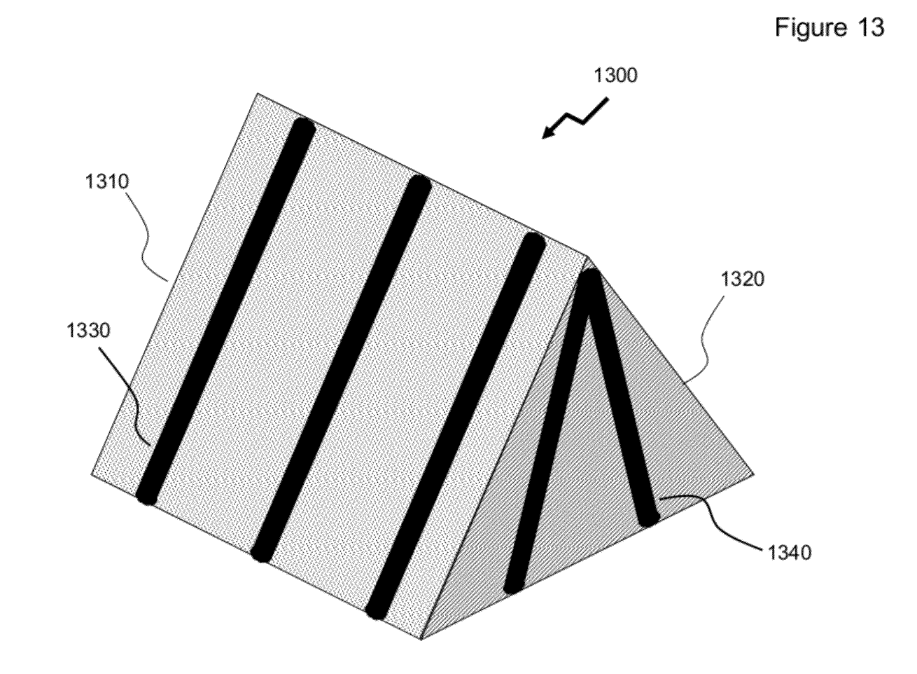

It would also be evident that the means can be employed with non-rectangular containers such as for example the triangular prism container 1300 in FIG. 13. In this instance the triangular prism container 1300 comprises two rectangular sidewalls 1310 and two triangular sidewalls 1320. Attached to the rectangular sidewalls 1310 are first elastic members 1330 and attached to the triangular sidewalls 1320 are second elastic members 1340 that fan from the narrow end of a triangular sidewall 1320 to the wide end of the triangular sidewall 1320.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a layer of a first material that is flexible;
attaching an elastic element to the layer of first material in a predetermined position to form a concertina layer, the attachment being performed with the layer of first material substantially extended and the elastic element extended by a predetermined amount, wherein
the concertina layer forms a predetermined portion of a storage container that adjusts dimensions in at least one axis according to the contents placed within.

2. A method according to claim 1 further comprising;
a layer of a second material that is flexible wherein the second layer is attached to at least one of the first material and elastic member.

3. A method according to claim 1 further comprising;
a layer of a second material that is flexible wherein the second layer is attached to at least one of the first material and elastic member.

4. A method comprising:
providing first and second walls of a storage container;
providing a third wall of the storage container connected to each of the first and second walls and comprising at least a layer of a first material that is flexible and an elastic element attached to the layer of material at a predetermined location, wherein
the sidewall is continuously adjustable between a first state and a second state, the first state being with the elastic member at a first length such that the layer of material is in a concertina structure and the second state being with the elastic member extended until the layer of material is at maximum extension.

5. A method according to claim 4 wherein,
the attachment of the elastic member and layer of the first material is performed at least one of with the layer of the first material substantially in a concertina arrangement and the elastic element unextended and with the layer of the first material substantially extended and the elastic element extended by a predetermined amount.

6. A method according to claim 4 further comprising;
a layer of a second material attached to at least one of the layer of the first material and the elastic member that comprise the third wall.

7. A method according to claim 5 further comprising;
attaching a layer of a second material to at least one of the layer of the first material and the elastic member that comprise the third wall during the attachment of the elastic member and the layer of the first material.

8. A method according to claim 4 wherein,
the first material and the material of the elastic element are compatible with the environments provided by at least one of a microwave, oven, refrigerator, freezer and dishwasher.

9. A device comprising:
a first wall;
a second wall;
a third wall of the storage container connected to each of the first and second walls and comprising at least a layer of a first material that is flexible and an elastic element attached to the layer of material at a predetermined location, wherein
the sidewall is continuously adjustable between a first state and a second state, the first state being with the elastic member at a first length such that the layer of material is in a concertina structure and the second state being with the elastic member extended until the layer of material is at maximum extension.

10. A device according to claim 9 wherein,
the attachment of the elastic member and layer of the first material is performed at least one of with the layer of the first material substantially in a concertina arrangement and the elastic element unextended and with the layer of the first material substantially extended and the elastic element extended by a predetermined amount.

11. A device according to claim 9 further comprising;
a layer of a second material attached to at least one of the layer of the first material and the elastic member that comprise the third wall.

12. A device according to claim 10 further comprising;
attaching a layer of a second material to at least one of the layer of the first material and the elastic member that comprise the third wall during the attachment of the elastic member and the layer of the first material.

13. A device according to claim 9 wherein,
the first material and the material of the elastic element are compatible with the environments provided by at least one of a microwave, oven, refrigerator, freezer and dishwasher.
